(19) United States
(12) Patent Application Publication
(10) Pub. No.: US 2002/0021742 A1
(43) Pub. Date: Feb. 21, 2002

(54) Manifold

(76) Inventors: Bruce W. Maskell, Fairfield, CA (US); Gene L. Pecci, Novato, CA (US)

Correspondence Address: BUCHANAN INGERSOLL, P.C., 301 GRANT STREET, 20TH FLOOR, PITTSBURGH, PA, 15219

(21) Appl. No.: 09/974,925

(22) Filed: Oct. 10, 2001

Related U.S. Application Data
(62) Division of application No. 09/189,282, filed on Nov. 10, 1998.

(51) Int. Cl. G01K 1/14

(52) U.S. Cl. 374/145; 137/115.26; 285/386; 165/174; 29/890.08; 236/93 R

(57) ABSTRACT

A manifold for a heat exchanging appliance is disclosed. The manifold may include an externally adjustable bypass valve, a compression fitting for connecting a conduit to the manifold, a flow cup for adding passes to the heat exchanging appliance, an apparatus for conveying the temperature of a medium in a nonconductive manifold to a temperature sensor, a blind threaded hole for engaging an insertion apparatus to the manifold, and an integrated thermostatic valve assembly. Methods for controlling the pressure in a pressure chamber, for connecting a conduit to a manifold, for adding passes to the heat exchanging appliance, for conveying the temperature of the medium to a temperature sensor, for engaging an insertion apparatus to the manifold, and for controlling the flow of a medium through the manifold are also disclosed.

### CROSS-REFERENCE TO RELATED APPLICATIONS

Not Applicable.

### FEDERALLY SPONSORED RESEARCH

Not Applicable.

### BACKGROUND OF THE INVENTION

1. Field of the Invention

The present invention relates to manifolds and, more particularly, to manifolds for use with heat exchanging appliances.

2. Description of the Invention Background

A variety of manifolds have been developed for integration into heat exchanging appliances used in heat exchanging applications. A typical heat exchanger includes a tube subassembly, a primary manifold and a secondary manifold.

A conventional tube subassembly is comprised of a series of heat conducting tubes disposed in parallel with the first end of each tube connected to the primary manifold and the second end of each tube connected to the secondary manifold. The purpose of the tube subassembly is to transfer heat from a high temperature medium to a low temperature medium while preventing the high and low temperature mediums from contacting each other. To accomplish that heat transfer in such a tube assembly, either the high or low temperature medium is forced through the heat conductive tubes while the other medium is forced to flow past the external surfaces of the tubes in contact therewith. When the high temperature medium contacts the lower temperature tubes, heat is transferred from the high temperature medium to the tubes. Likewise, heat is transferred from the tubes to the lower temperature medium as the low temperature medium contacts the tubes. Thus, heat from the high temperature medium is transferred through the heat conductive tubes to the lower temperature medium.

Although a variety of mediums have been used, one or both of the mediums may be in the form of a gas such as steam or air. Alternatively, one or both of the mediums may be a liquid such as water or glycol. In a swimming pool heating application, for example, air may be heated by direct contact with a flame or other heat source. The heated air then rises, contacting and heating the heat conductive tubes. Lower temperature pool water is simultaneously forced through the heat conductive tubes where it absorbs heat from the tubes. The pool water is circulated through the heat exchanger and a pool, thereby raising the temperature of the water in the pool.

The heat conductive tubes of the tube subassembly are typically made of a metal, such as copper, brass, aluminum, iron or steel, that has a high heat transfer coefficient and can withstand prolonged exposure to both the high and low temperature mediums.

Manifolds operate to direct a medium through the tubes of the tube subassembly. The primary manifold typically receives the medium from a piping system, distributes the medium to the tubes of the tube subassembly, and directs medium that has passed through the tube subassembly back to the piping system. Most primary manifolds, regardless of type, comprise a housing member having an inlet port defined by an inlet socket, an outlet port defined by an outlet socket, and an inner cavity. The inlet socket and the outlet socket are constructed for attachment to corresponding portions of a pipeline. Some sockets are provided with threaded connections, while others utilize a “slip fit” connection wherein a conduit that is a section of the pipeline is slidably received in the socket. The conduit is typically retained within the socket by an appropriate attachment medium or adhesive. For example, the conduit may be affixed to the socket by welding, soldering or gluing. A slip fit conduit may also be retained within the socket by mechanical means such as, for example, the use of flanges with gaskets and mechanical fasteners.

The flow characteristics afforded by a manifold are generally dependent on the number of sections into which the manifold cavity is divided. The inner cavity of the primary and secondary manifolds may be divided into multiple chambers such that each chamber is in fluid communication with only a portion of the tubes of the tube subassembly. Such an arrangement permits fluid to be forced to flow from the inlet of the primary manifold, through selected tubes to the secondary manifold, and return to the primary manifold through other selected tubes. For example, the inner cavity of the primary manifold housing may be divided into two chambers wherein an inlet chamber is in fluid communication with the inlet port and several tubes such that medium entering the manifold through the inlet port is directed into those tubes; and an outlet chamber portion of the cavity is in fluid communication with the outlet port and several other tubes such that medium flowing through those tubes is returned to the piping system through the outlet port. A primary manifold having only those two cavity sections is commonly referred to as a “two-pass manifold,” and a heat exchanger incorporating such a manifold is commonly referred to as a “two-pass system,” because medium passes through tubes of the tube subassembly once after leaving the inlet chamber of the manifold cavity and then makes a second pass through other tubes before returning to the outlet chamber of the primary manifold.

Other primary manifolds divide the cavity of the manifold into a third chamber that is in fluid communication only with a number of the tubes of the tube subassembly and not with either the inlet port or outlet port. The purpose of the third chamber is to direct fluid flowing into the chamber from several tubes, into other tubes carrying fluid away from the third chamber. A primary manifold having such a third chamber is commonly referred to as a “four-pass manifold,” and a heat exchanger incorporating such a manifold is referred to as a “four-pass system” because medium makes an additional pass through tubes of the tube subassembly when returning to the third chamber of the manifold and yet another pass through other tubes when leaving the third chamber.

A secondary manifold may also be utilized to connect the ends of the tubes of the tube subassembly opposite the primary manifold. The secondary manifold may not contain a connection to the piping system but may simply be utilized to return the medium to the primary manifold. In a two-pass system, the secondary manifold ordinarily has a single chamber common to all of the tubes. In a four-pass system, the secondary manifold is usually divided into a leading chamber and a trailing chamber. In a four-pass system the medium typically makes a first pass, flowing from the inlet chamber of the primary manifold, through a first set of tubes, to the leading chamber of the secondary manifold; a second pass through a second set of tubes to the third chamber of the primary manifold; a third pass through a third set of tubes to the trailing chamber of the secondary manifold; and a fourth pass through a fourth set of tubes to the outlet chamber of the primary manifold.

Two and four-pass systems offer different heating characteristics. Four-pass systems generally increase the temperature of the heated medium more than two-pass systems, while two-pass systems generally heat a greater volume of medium in a given time than do four-pass systems. Therefore, system dynamics usually dictate whether a two or four-pass heat exchanger is preferred in a particular system.

While such manifolds can effectively direct flow from a pipeline through a tube subassembly, conventional manifold designs have various shortcomings. For example, in a pool heating system, pipeline pressures vary depending on pumping equipment utilized, frictional losses in the pipeline, system demands from other equipment drawing from the pipeline such as filters, and other factors. A conventional manifold may incorporate a bypass valve, located between the inlet and outlet chambers of the primary manifold to allow water to flow directly from the inlet chamber to the outlet chamber when the inlet pressure is greater than the pressure under which the heat exchanger is designed to operate. The bypass valve, however, has limited utility because it may only be adjusted by disassembling the manifold. Therefore, there is a need for a manifold incorporating an externally adjustable bypass valve.

Connection of a conventional manifold to a piping system can be labor intensive and typically requires the employment of a person skilled in making such connections. Conventional connections are also difficult to repair when a failure occurs. Slip fit connections require each conduit to be properly cleaned and prepared, often requiring the use of specialized solutions. The piping connections must then be joined together by gluing or welding. Both glued and welded joints are susceptible to leakage and repair of such a leak is often difficult. Glued connections, for example, are typically not designed to be disconnected. Therefore, the components joined by a failed glued connection may not be repaired and must typically be removed and discarded. Threaded connections, likewise, require that each conduit be properly cleaned and prepared, and often require the use of specialized solutions. While a manifold may be pre-threaded, conduit typically must be cut to length and threaded at the installation site, which requires the use of specialized threading machinery. Disassembly and reassembly of threaded piping systems can also be very difficult because it necessitates the removal of the entire piping system to a point where a connection other than a standard threaded connection is utilized. Therefore, a need exists for a manifold connection that permits an unskilled person to connect a piping system to the manifold quickly and simply, and permits ease of removal and reconnection.

Additionally, conventional manifolds are configured for use in either a two-pass or a four-pass system but not both. Meeting the requirements of different heat exchanging systems is made cumbersome and expensive by the need to manufacture and stock both two and four-pass manifolds to meet varying system requirements. Therefore, there is a need for manifolds that may be utilized in both two and four-pass heat exchanging systems.

It is often desirable to include an optional sensor, such as a temperature or pressure sensor, in a manifold. A manifold that includes the appropriate number of sensor ports must be utilized in such applications. Where no optional sensors are to be utilized at the manifold, it may be preferable to utilize a manifold having no sensor ports to minimize the risk that medium will leak from the manifold. Once again, the necessity of manufacturing and stocking multiple manifolds having varying port configurations is cumbersome and expensive. Therefore, a need exists for a manifold that can be easily configured for the inclusion of sensors.

It is also often desirable to control the flow of medium in a manifold in relation to the temperature of the medium. A certain conventional manifold utilized a thermostatic valve, located in the pipeline external to the manifold, to regulate the flow of medium as the temperature of the medium changes. Thus, a desired amount of heat may be introduced into the pool regardless of fluctuations in the amount of heat added to the pool water in the heat exchanging appliance. Additional labor is, however, required to install the thermostatic valve in the pipeline. Therefore, there is a need for a thermostatic valve assembly that may be incorporated into a manifold.

### SUMMARY OF THE INVENTION

The present invention is directed to a manifold for a heat exchanging appliance. The manifold includes several features that allow the manifold to be used in a wide variety of applications.

An externally adjustable bypass valve is provided. The bypass valve permits a medium passing into a chamber of a housing to selectively bypass the chamber when the medium achieves a preselected pressure within the chamber. The bypass valve includes a poppet movably supported within the chamber between sealing engagement with an outlet in the chamber and non-sealing engagement with the outlet. The bypass valve also includes an adjustable actuation assembly attached to the poppet and protruding from the housing for external access. The actuation assembly selectively applies a biasing force to the poppet to retain the poppet in sealing engagement with the outlet until the medium pressure exceeds the biasing force.

The bypass valve may include a shaft having a proximal end extending through an appliance housing, a distal end, a stop, a threaded follower segment intermediate the distal end and the stop, and a key in the proximal end of the shaft to facilitate rotation of the shaft. The bypass valve may also include a follower having at least one anti-rotation surface for engaging the housing and a threaded hole for engaging the threaded follower segment of the shaft, whereby the follower moves along the threaded follower segment of the shaft when the shaft is rotated. The bypass valve may further comprises a biasing member disposed intermediate the follower and the poppet and a removable plug to facilitate removal of the bypass valve from the manifold.

A method of controlling the pressure in a high pressure chamber with respect to the pressure in a low pressure chamber in fluid communication with the high pressure chamber is also provided. The method includes biasing a poppet between the high and low pressure chambers and varying the biasing force applied to the poppet from outside the high and low pressure chambers.

A compression fitting for connecting a conduit and a piping socket is also provided. The compression fitting includes a compression nut having a compression end and a threaded surface for engaging a threaded surface of the piping socket. The compression fitting also includes an inner ring having a retaining portion and an outer ring. The inner ring is disposed on the conduit intermediate the compression end of the compression nut and the piping socket and the outer ring is disposed on the retaining portion of the inner ring. The outer ring may optionally include one or more compression joints.

A flow cup is further provided. The flow cup includes a flow cup body having an endless wall defining a chamber. The flow cup may be placed in a manifold to add one or more passes to the heat exchanging appliance.

An apparatus for conveying the temperature of a medium in a nonconductive housing to a temperature sensor is also provided. The apparatus includes a heat conductive stud disposed through a hole in the housing and a fastener to retain the stud in the hole. The apparatus may also include a sensor socket formed on the housing for containing the temperature sensor and maintaining the temperature sensor in proximate relationship to the stud. In addition the apparatus may include a sensor cover, for placement on the rim of the sensor socket, to enclose the sensor in the sensor socket.

A manifold having a blind threaded hole for engaging an insertion apparatus is also provided. The blind threaded hole includes a fitting engaging portion extending from the manifold and a portion of the manifold enclosed by the fitting engaging portion, wherein the portion of the manifold enclosed by the fitting engaging portion may be removed and a fitting attached to the fitting engaging portion.

A thermostatic valve assembly is further provided. The thermostatic valve assembly includes a thermostatic valve that operates to selectively permit medium flow and a biasing member urging the thermostatic valve toward a port to restrict flow around the thermostatic valve. The thermostatic valve assembly may also include an interface for selectively retaining and orienting the thermostatic valve assembly.

The present invention offers the feature of permitting a bypass valve to be removed or adjusted without disassembling the manifold. Another feature of the present invention is to permit an unskilled person to connect a piping system to the manifold quickly and simply and to further permit ready removal and reconnection of the piping system. The present invention also offers the feature that permits a manifold to be used in either a two- or four-pass system. The present invention further provides optional sensor interface features. In addition the present invention provides a feature whereby the flow of medium through the manifold is internally controlled in relation to the temperature of the medium in the manifold. Accordingly, the present invention provides solutions to the shortcomings of conventional manifold arrangements. Those of ordinary skill in the art will appreciate, however, that these and other details, features and advantages will become further apparent as the following detailed description proceeds.

### BRIEF DESCRIPTION OF THE DRAWINGS

In the accompanying Figures, there are shown present preferred embodiments of the invention wherein like reference numerals are employed to designate like parts and wherein:

FIG. 1 is an exploded assembly view of a heat exchanger of the present invention;

FIG. 2 is a perspective view of the heat exchanger of FIG. 1;

FIG. 3 is an exploded assembly view of the primary manifold of the heat exchanger shown in FIGS. 1 and 2;

FIG. 4 is a perspective view of the tube assembly interconnect member and bypass valve employed in the primary manifold of FIG. 3;

FIG. 5 is an enlarged cross-sectional view of the bypass valve of FIG. 4 and the section of the primary manifold of FIG. 4 in which the bypass valve is installed, taken along line V-V in FIG. 4;

FIG. 6 is an exploded assembly view of the bypass valve of FIGS. 3-5;

FIG. 7 is a side view of the shaft of the bypass valve of FIG. 6;

FIG. 8 is an end view of the shaft of FIGS. 6 and 7;

FIG. 9 is a front perspective view of the poppet of the bypass value of FIG. 6;

FIG. 10 is a rear perspective view of the poppet of FIG. 9;

FIG. 11 is a front elevational view of the poppet of FIGS. 9 and 10;

FIG. 12 is a rear view of the poppet of FIGS. 9-11;

FIG. 13 is a cross-sectional view of the poppet of FIG. 12, taken along line XIII-XIII in FIG. 12;

FIG. 14 is a cross-sectional view of the poppet of FIG. 12, taken along line XIV-XIV in FIG. 12;

FIG. 15 is a front elevational view of the follower of the bypass valve of FIG. 6;

FIG. 16 is a rear view of the follower of FIG. 15;

FIG. 17 is a cross-sectional view of the follower of FIG. 15, taken along line XVII-XVII in FIG. 15;

FIG. 18 is a rear perspective view of the plug of the bypass value of FIG. 6;

FIG. 19 is a front perspective view of the plug of FIG. 18;

FIG. 20 is a front view of the plug of FIGS. 18 and 19;

FIG. 21 is a side elevational view of the plug of FIGS. 18-20;

FIG. 22 is a rear view of the plug of FIGS. 18-21;

FIG. 23 is a cross-sectional view of the plug of FIG. 20, taken along line XXIII-XXIII in FIG. 20;

FIG. 24 is a cross-sectional view of the plug of FIG. 20, taken along line XXIV-XXIV in FIG. 20;

FIG. 25 is a cross-sectional view of the bypass valve of FIG. 6, taken along line XXV-XXV of FIG. 6;

FIG. 26 is an exploded assembly view of the primary manifold of FIGS. 1-3 and a compression fitting of the present invention;

FIG. 27 is an enlarged cross-sectional view of the manifold and compression fitting of FIG. 26, taken along line XXVII-XXVII in FIG. 26, illustrating the compression fitting in attachment with the manifold;

FIG. 28 is an exploded assembly view of the sealing member of the compression fitting of FIGS. 26 and 27;

FIG. 29 is a cross-sectional view of the sealing member of FIG. 28, taken along line XXIX-XXIX of FIG. 28;

FIG. 30 is an enlarged side view of an compression joint of the outer ring of FIG. 28;

FIG. 31 is an exploded assembly view of the primary manifold of FIGS. 1-3 and a flow cup of the present invention;

FIG. 32 is a rear elevational view of the manifold and flow cup of FIG. 31 with the flow cup installed therein;

FIG. 33 is a front perspective view of the flow cup of FIGS. 31 and 32;

FIG. 34 is a rear perspective view of the flow cup of FIGS. 31-33;

FIG. 35 is a rear elevational view of the flow cup of FIGS. 31-34;

FIG. 36 is a cross-sectional view of a temperature sensing apparatus of the present invention installed in a manifold;

FIG. 37 is a cross-sectional view of a dual temperature sensing apparatus of the present invention installed in a manifold;

FIG. 38 is a perspective view of the primary manifold of FIGS. 1-3 incorporating the sensor sockets of FIGS. 36 and 37;

FIG. 39 is a rear perspective view of the primary manifold of FIG. 38;

FIG. 40 is an enlarged rear view of the dual sensor socket of FIG. 39;

FIG. 41 is a front perspective view of the primary manifold of FIGS. 38 and 39;

FIG. 42 is an enlarged front view of the dual sensor socket of FIG. 41;

FIG. 43 is an enlarged front view of the dual sensor socket of FIGS. 38-42;

FIG. 44 is an enlarged side elevational view of the dual sensor socket of FIGS. 38-43;

FIG. 45 is an enlarged rear view of the dual sensor socket of FIGS. 38-44;

FIG. 46 is a cross-sectional view of the dual sensor socket of FIG. 43, taken along line XLVI-XLVI of FIG. 43;

FIG. 47 is an exploded assembly view of the primary manifold of FIG. 38 and temperature sensors and sensor covers of the present invention;

FIG. 48 is an enlarged exploded assembly view of the temperature sensing apparatus of FIG. 47;

FIG. 49 is an enlarged exploded assembly view of the dual temperature sensing apparatus of FIG. 47;

FIG. 50 is a cross-sectional view of a blind threaded hole of the present invention in a manifold;

FIG. 51 is a cross-sectional view of a tapped blind threaded hole of the present invention in a manifold; and

FIG. 52 is an exploded assembly view of the primary manifold of FIGS. 1-3 and a thermostatic valve assembly of the present invention.

### DETAILED DESCRIPTION OF THE INVENTION

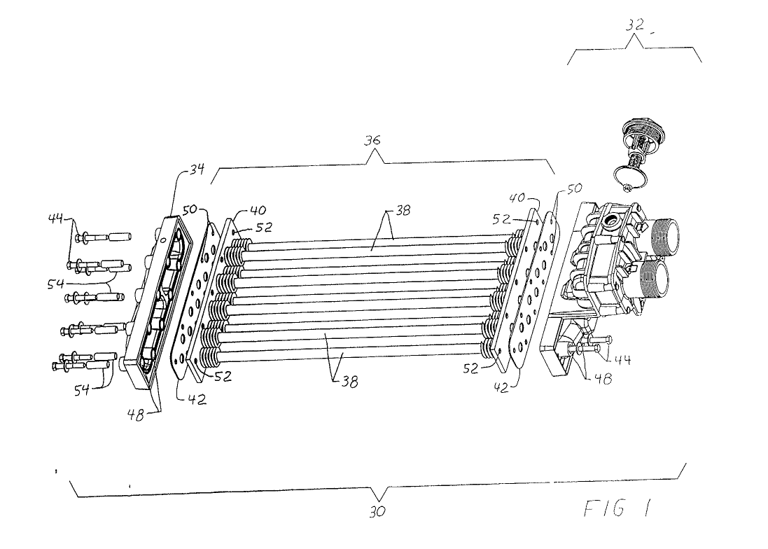

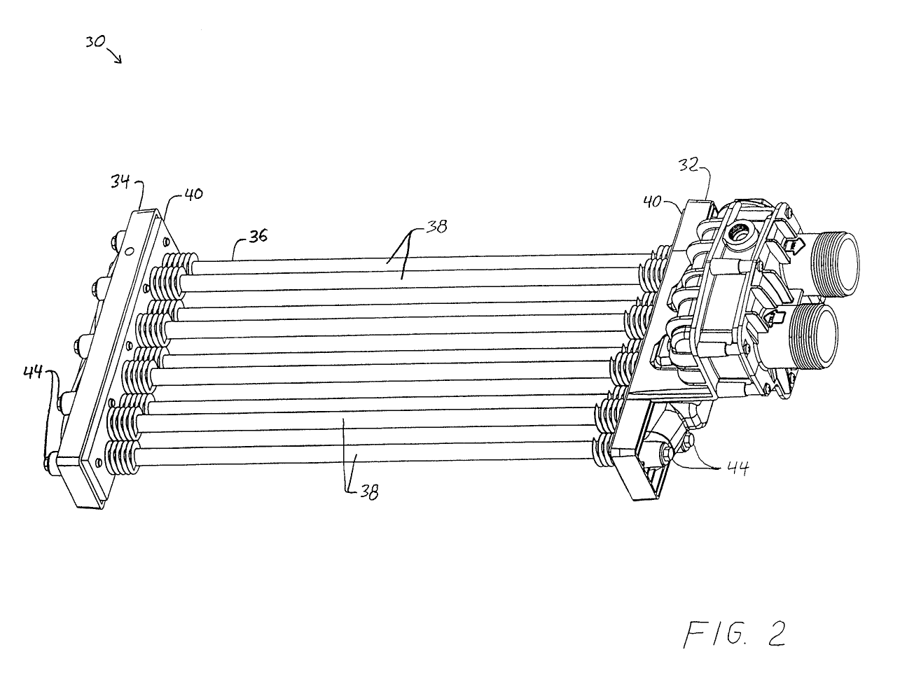

Referring now to the drawings for the purpose of illustrating present preferred embodiments of the invention only and not for the purpose of limiting the same, FIG. 1 illustrates an exploded perspective view of a heat exchanging appliance 30 including a primary manifold 32 constructed in accordance with the present invention. FIG. 2 illustrates an assembled view of the same heat exchanger 30 illustrated in FIG. 1. Those skilled in the art will recognize that many heat exchanger embodiments may be utilized in cooperation with the manifold 32 of the present invention and will be able to incorporate the manifold 32 into heat exchanging appliances other than those illustrated herein. In addition to the manifold 32 constructed in accordance with the present invention, the heat exchanger 30 embodiment illustrated in FIGS. 1 and 2 includes a secondary manifold 34 and a heat transferal subassembly 36 such as, for example, a tube subassembly.

The heat transferal subassembly 36 illustrated, includes a plurality of tubes 38, a pair of connecting brackets 40, and a pair of manifold gaskets 42. The primary manifold 32 and secondary manifold 34 may be connected to the heat transferal subassembly 36 by way of capscrews 44. The capscrews 44 may each pass through an aperture 48 in the manifold (32, 34), and an aperture 50 in the manifold gasket 42, to engage a threaded hole 52 in the connecting bracket 40. Sleeves 54 may be incorporated into the manifold apertures 48 to prevent damage to the manifold (32, 34) that might otherwise occur when the capscrews 44 are tightened directly against the manifold (32, 34).

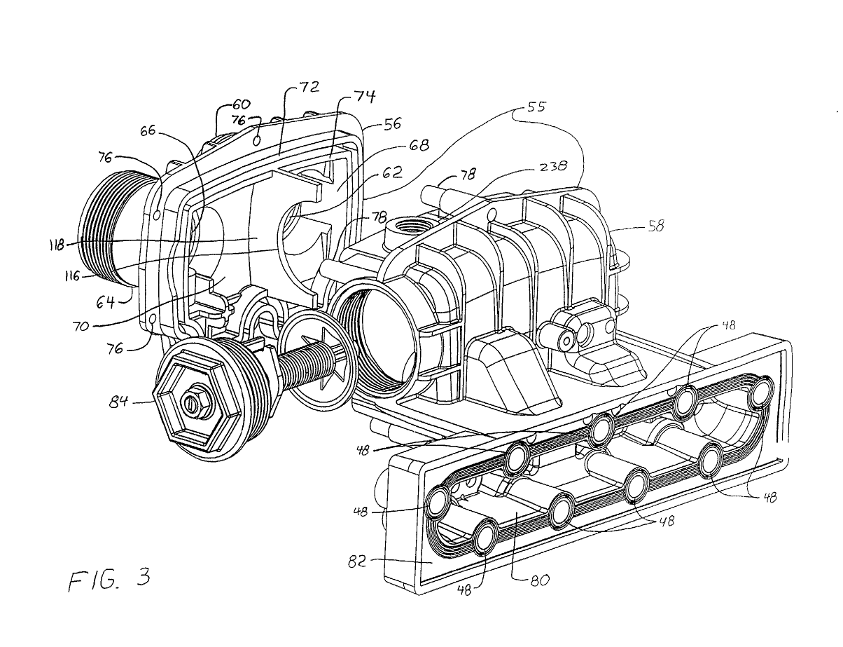

FIG. 3 illustrates an exploded assembly view of an embodiment of the primary manifold 32 constructed in accordance with the present invention. The manifold housing 55 may be formed in one piece to minimize manufacturing costs, or may be formed in more than one piece to facilitate access to inner portions of the manifold 32 or for ease of manufacturing. The embodiment illustrated is formed in two pieces, a piping system interconnect member 56 and a tube assembly interconnect member 58.

The piping system interconnect member 56 may include an inlet piping socket 60 that forms an inlet port 62, an outlet piping socket 64 that forms an outlet port 66, an inlet chamber 68, an outlet chamber 70 an endless outer rib 72 and an endless inner rib 74. The piping system interconnect member 56 may also include a plurality of bolt holes 76 that correspond to bolt receptacles 78 in the tube assembly interconnect member 58 for interconnection of the piping system interconnect member 56 and the tube assembly interconnect member 58.

The tube assembly interconnect member 58 may also include an inlet chamber 68′ and an outlet chamber 70′ or portions of an inlet chamber 68′ and an outlet chamber 70′ that correspond to portions of the inlet and outlet chambers 68 and 70 of the piping system interconnect member 56. The tube assembly interconnect member 58 also includes a cavity 80 which collects medium from the inlet chamber 68 and distributes the medium to the heat transferal subassembly 36. A section, such as, for example, the tube assembly interconnect surface 82 of FIG. 3, suitable for connecting the manifold to a heat transferal subassembly 36, is also provided in the tube assembly interconnect member 58. A plurality of manifold apertures 48 that correspond to threaded holes 52 in the heat transferal subassembly 36 may be provided in the tube assembly interconnect surface 82 for interconnecting the manifold 32 to the heat transferal subassembly 36.

A variety of sensing devices, such as, for example, temperature and pressure sensors, and control devices, such as, for example, thermostatic valves and bypass valves, may also be provided in the manifold 32 of the present invention.

FIG. 3 illustrates one such bypass valve 84 which may be provided in a manifold 32 to permit medium present in the inlet chamber 68 to pass directly to the outlet chamber 70 without passing through the heat transferal subassembly 36. The bypass valve 84 may be provided to prevent the heat transferal subassembly 36 from being damaged by differential pressure between the medium in the inlet chamber 68 and the medium in the outlet chamber 70 that is greater than the differential pressure at which the heat transferal subassembly 36 is designed to operate.

FIG. 4 illustrates the bypass valve 84 operably disposed in the manifold 32 and FIG. 5 depicts a cross-sectional view of a section of the manifold 32 with the bypass valve 84 operably disposed in the manifold 32.

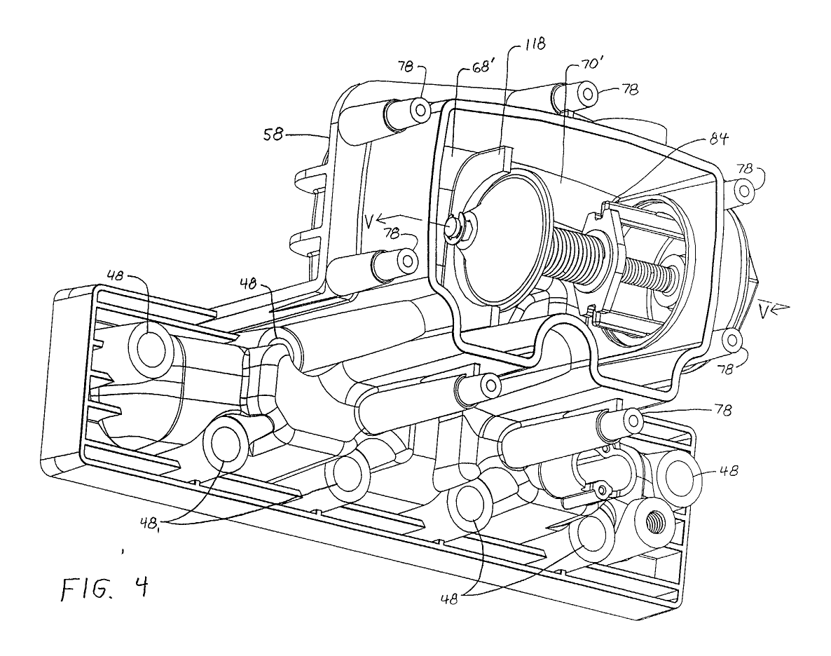

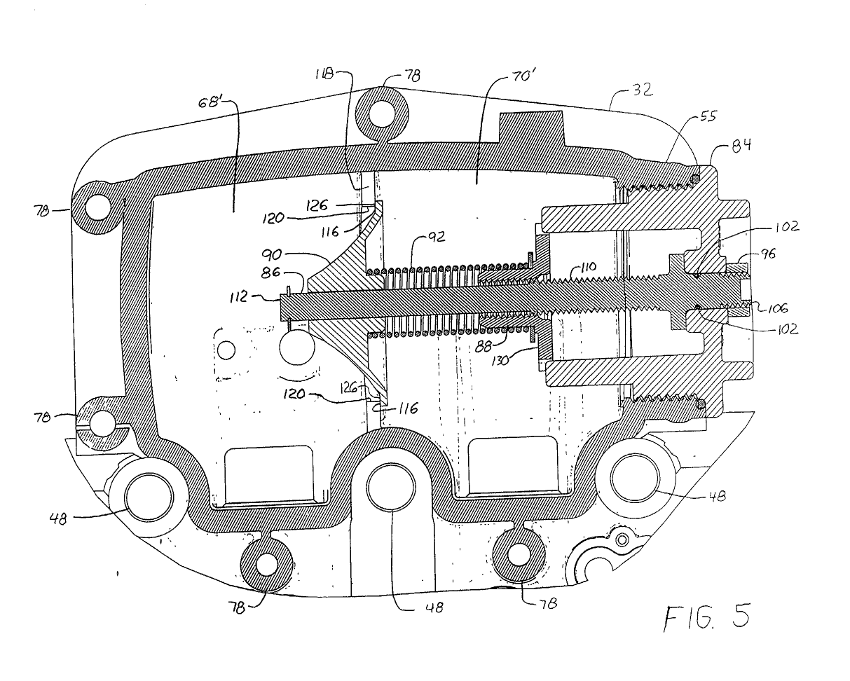

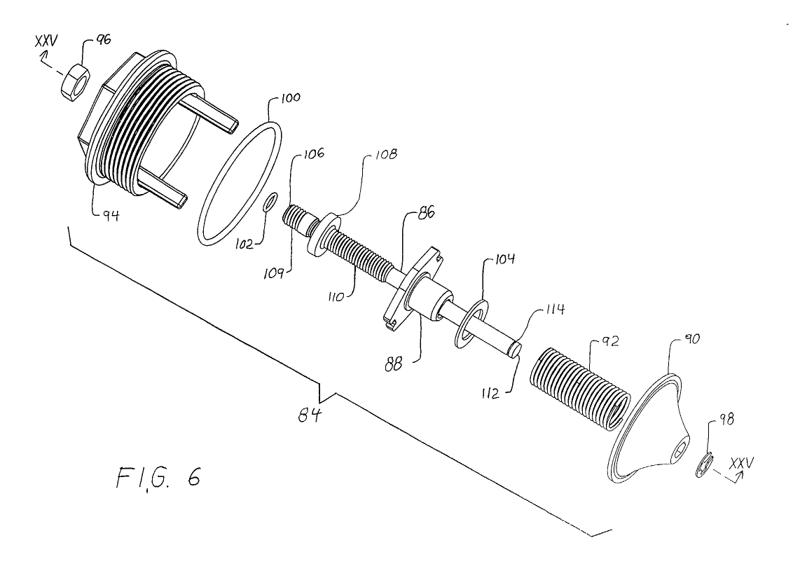

FIG. 6 illustrates an exploded assembly view of the bypass valve 84 which includes a shaft 86, a follower 88, a poppet 90, and a biasing member 92. The bypass valve 84 may also include a plug 94 for removably retaining the bypass valve 84 in the manifold 32, an adjustment nut 96 for clamping the bypass valve 84 against the manifold housing 55 or plug 94, a retaining member 98 to limit movement of the poppet 90, a plug gasket 100 for sealing between the plug 94 and the manifold housing 55, a shaft gasket 102 for sealing between the shaft 86 and the plug 94 or manifold housing 55, and a follower washer 104 that may be placed between the follower 88 and the biasing member 92 to prevent the biasing member 92 from impinging on the follower 88.

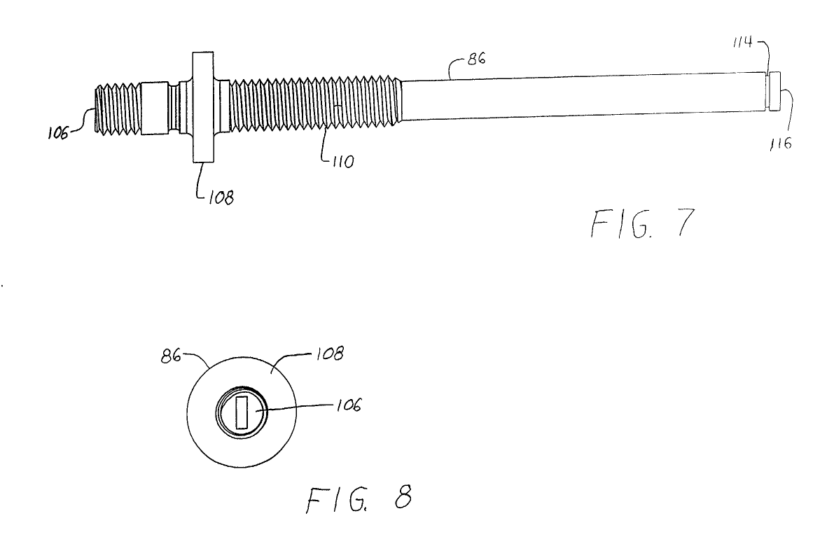

FIG. 7 illustrates a side view of the shaft 86 and FIG. 8 illustrates the shaft 86 as viewed from the proximal end. The shaft 86 is constructed so that its proximal end 106 can extend through the manifold housing 55. The proximal end 106 may be keyed, as illustrated in FIG. 8, so that the shaft 86 may be engaged by a tool, such as, for example, a standard screwdriver, and rotated to adjust the force applied to the poppet 90 by the biasing member 92 without disassembly of the manifold 32. The shaft 86 also has a stop 108 such as, for example, a collar extending axially from the shaft, near its proximal end 106. The stop 108 prevents the shaft 86 from extending through the manifold housing 55 beyond the stop 108. The external surface 109 of the proximal end 106 of the shaft 86, may include a threaded segment so that the adjustment nut 96 may be utilized to retain the shaft 86 in place against the manifold 32 when the proximal end 106 is extended through the manifold housing 55. When the adjustment nut 96 is tightened, it also prevents rotation of the shaft 86, thereby preventing movement of the follower 88 along the shaft 86. The shaft 86 also includes a threaded follower segment 110 intermediate the stop 108 and the distal end 112 of the shaft 86. Near its distal end 112, the shaft 86 may include a poppet retaining member engagement portion, such as, for example, an endless slot 114 extending around the shaft. A retaining member 98, such as, for example, a conventional or commercially available retaining ring may engage the endless slot 114 to limit movement of the poppet 90 on the shaft 86.

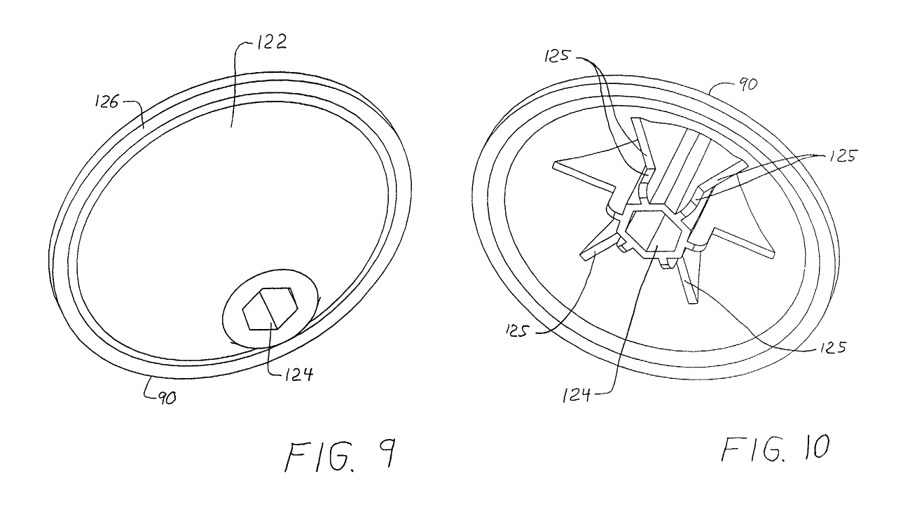

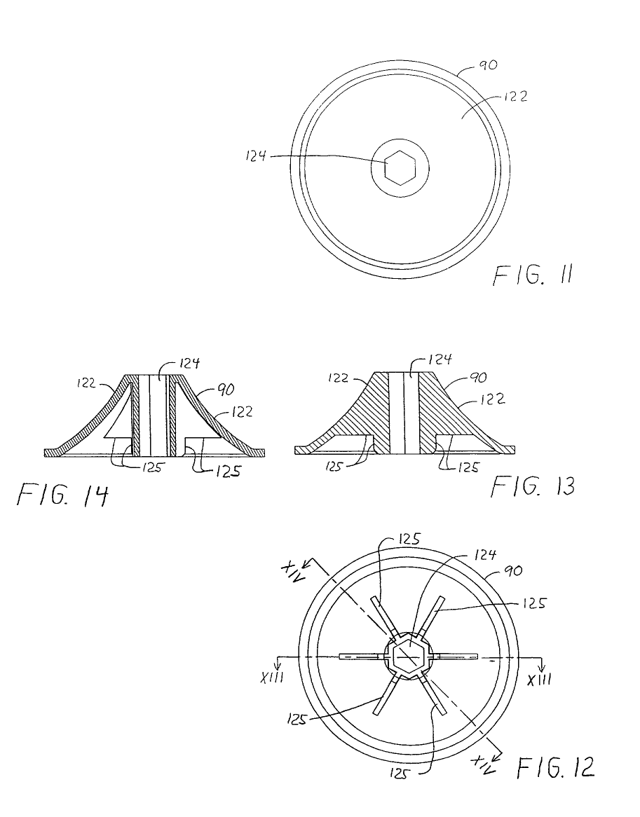

FIGS. 9-14 illustrate a poppet 90, constructed in accordance with the present invention. As may be seen in FIGS. 4 and 5, the poppet 90 is adapted to engage a seat 116 of a dividing wall 118 surrounding a bypass port 120 between the inlet chamber 68 and outlet chamber 70. As may be seen in FIGS. 9 and 10, the poppet 90 includes a flow control surface 122, a shaft passage 124, a seat engaging surface 126, and a biasing member engaging section 125. The flow control surface 122 may be formed in many configurations to achieve desired flow characteristics through the bypass port 120. The flow control surface 122 may, for example, be conical with linear, convex or concave sides to provide, for example, a linear relationship between poppet 90 movement and flow through the bypass port 120. The shaft 86 is operably received in the shaft passage 124 which may be keyed to prevent rotation of the poppet 90 on the shaft 86. The seat engaging surface 126 engages the seat 116 of the dividing wall 118 to prevent flow through the bypass port 120 until an increase in differential pressure between the inlet chamber 68 and the outlet chamber 70, thereby moving the seat engaging surface 126 away from the seat 116 displaces the poppet 90. Thus, the medium is permitted to flow through the bypass port 120 when differential pressure increases a sufficient amount to overcome the force generated by the biasing member 92. The biasing member engaging section 125 of the poppet 90 is provided as an interface for the biasing member 92.

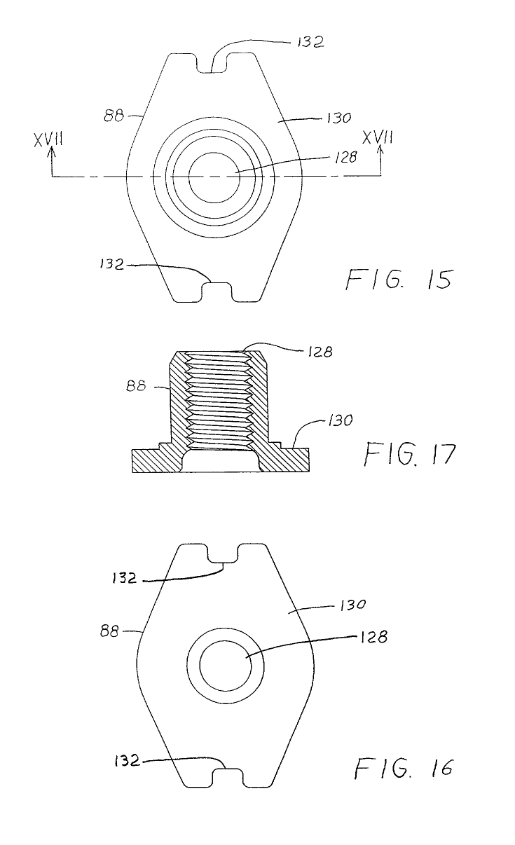

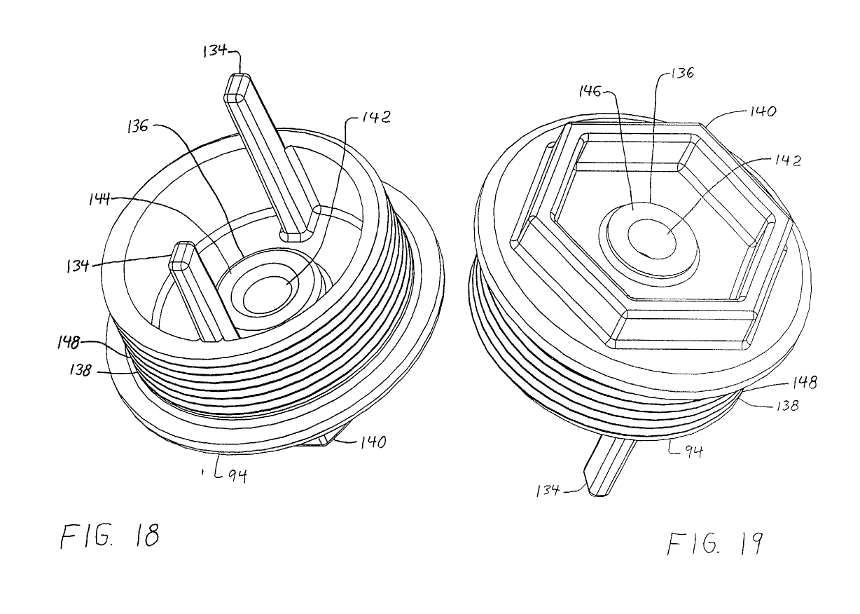

FIGS. 15-17 illustrate a follower 88 constructed in accordance with the present invention. As illustrated in FIG. 15, the follower 88 has a threaded hole 128 and an anti-rotational surface 130. The threaded hole 128 is configured to rotationally engage the threaded follower segment 110 of the shaft 86. The anti-rotational surface 130 may, for example, have two opposing bifurcations 132 for engagement with standing ribs 134 (illustrated in FIG. 25) on the manifold housing 55 or plug 94.

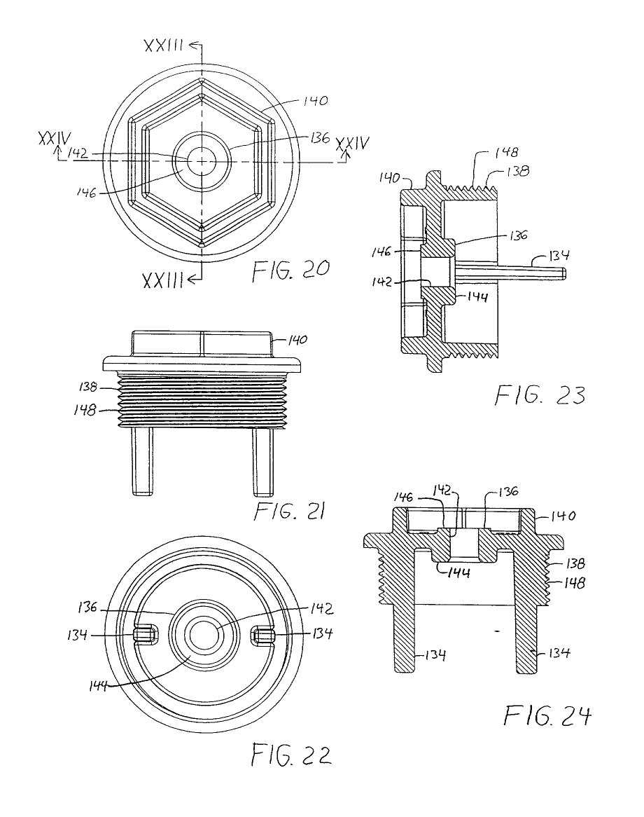

FIGS. 18-24 illustrate a removable plug 94 that may optionally be incorporated into the manifold 32 to facilitate removal of the bypass valve 84. As may be seen in FIGS. 18 and 19, the plug 94 may include a pair of linear standing ribs 134, a shaft retaining member 136, a manifold housing engagement portion 138, and a gripping portion 140 for use when rotating the plug 94. The standing ribs 134 engage the bifurcations 132 of the follower 88 to prevent rotation of the follower 88. The shaft retaining member 136 may define a shaft retaining passage 142 through which the proximal end 106 of the shaft 86 projects. The shaft retaining member 136 may also include a stop engaging surface 144 and an opposing nut engaging surface 146 such that the shaft may be disposed through the shaft retaining passage 142 until the stop 108 engages the stop engaging surface 144, and the adjustment nut 96 may be threaded onto the proximal end 106 of the shaft 86 to engage the nut engaging surface 146, thereby clamping the shaft 86 to the plug 94. The manifold housing engagement portion 138 may include, for example, a threaded surface 148 as illustrated in FIG. 18. The threaded surface 148 may be configured to sealingly engage the manifold housing 55 when the removable plug 94 is screwed into the housing 55. The gripping portion 140 provides a structure that may be engaged by a tool. The gripping portion 140 may, for example, include an endless wall having six linear sides or a hex shaped projection extending from the plug 94. The tool may be, for example, a wrench, which facilitates rotation of the plug 94 to engage the plug 94 and the manifold housing 55.

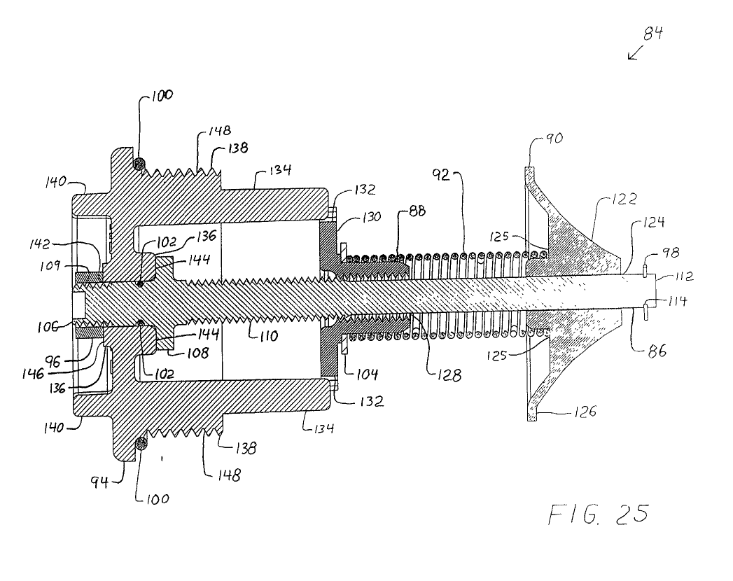

FIGS. 20-22 illustrate top side and bottom views of the plug 94, respectively. FIGS. 23 and 24 illustrate cross-sectional views of the plug illustrated in FIGS. 18-22.

FIG. 25 illustrates a cross-sectional view of an embodiment of the bypass valve 84 constructed in accordance with the present invention. A plug gasket 100 such as, for example, an O-ring, may be provided between the plug 94 and manifold housing 55 to facilitate a fluid- tight seal between the plug 94 and the manifold housing 55. A shaft gasket 102, which may also be an O-ring, may be provided between the plug 94 and shaft 86 or the housing 55 and shaft 86 in applications in which a plug 94 is not utilized, to facilitate a fluid-tight seal between the plug 94 or housing 55 and shaft 86.

Referring to the embodiment illustrated in FIG. 25, the poppet 90 is disposed on the distal end 112 of the shaft 86. The retaining member 98 includes a retaining ring in this embodiment and is disposed in the slot 114 at the distal end 112 of the shaft 86 to limit travel of the poppet 90. In this embodiment, the biasing member 92 comprises a coil spring. The biasing member 92 rests against the biasing member engagement section 125 of the poppet 90, thereby forcing the poppet 90 against the dividing wall seat 116 to prevent medium flow between the inlet chamber 68 and outlet chamber 70. The biasing member 92 extends from the biasing member engagement section 125 of the poppet 92 to the follower 88. In the embodiment illustrated, a follower washer 104 is disposed between the biasing member 92 and follower 88 to prevent follower wear that may be caused by the biasing member 92. The follower 88 is threaded onto the threaded follower segment 110 of the shaft 86 and the bifurcations 132 are engaged with the standing ribs 134 of the plug 94. The proximal end 106 of the shaft 86 extends through the plug 94 and is clamped thereto by the adjustment nut 96.

In operation, as shown in FIG. 5, the bypass valve 84 is inserted into the manifold 32 so that the seat engaging surface 126 of the poppet 90 is forced against the dividing wall seat 116 to prevent medium from flowing through the bypass port 120. When pressure in the high pressure inlet chamber 68′ exceeds the sum of the pressure in the low pressure outlet chamber 70′ and the force applied to the poppet 90 by the biasing member 92, the poppet 90 is forced away from the distal end 112 of the shaft 86 and the dividing wall seat 116, thereby permitting medium to flow directly from the inlet chamber 68′ to the outlet chamber 70′, without first passing through the heat transferal subassembly 36.

The force that is applied to the poppet 90 by the biasing member 92 may be adjusted by rotating the shaft 86. It is convenient to rotate the shaft 86 at the keyed proximal end 106 because that portion of the shaft extends through the manifold housing 55 and is, therefore, easily accessible. When the shaft 86 is rotated, the follower 88, which is prevented from rotating by the anti-rotational surface 130, moves along the threaded follower segment 110. When the shaft 86 is rotated such that the follower 88 moves toward the proximal end 106 of the shaft 86, the force applied to the poppet 90 by the biasing member 92 is reduced. Conversely, when the shaft 86 is rotated such that the follower 88 moves toward the distal end 112 of the shaft 86, the force applied to the poppet 90 by the biasing member 92 is increased. After the biasing member 92 has been adjusted to the desired force setting, the adjustment nut 96 may be tightened to prevent further rotation of the shaft 86. Thus, the biasing force applied to the poppet 90 may be adjusted from outside of the manifold 32 of the present invention.

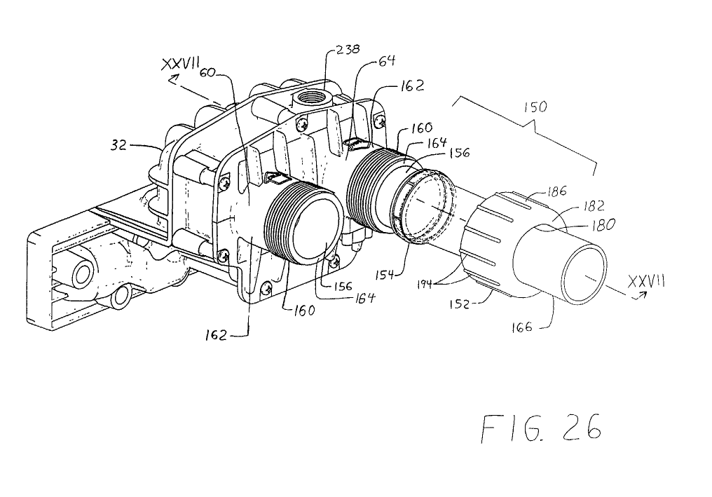

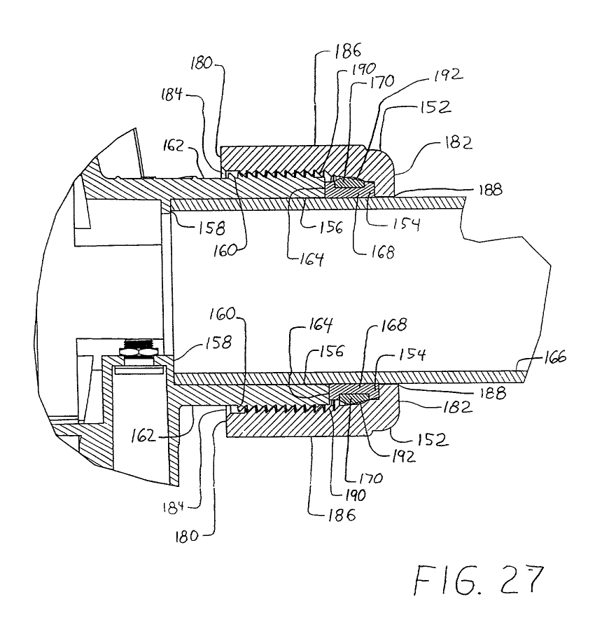

FIGS. 26-30 illustrate a compression fitting 150 of the present invention for connecting the manifold 32 to a conduit. FIG. 26 illustrates a manifold 32 of the present invention and an exploded view of the compression fitting 150. The compression fitting includes a compression nut 152 and a sealing member 154. The inlet piping socket 60 and outlet piping socket 64 may each be provided with a smooth internal conduit receiving surface 156, a conduit curb 158 (illustrated in FIG. 27), a male thread 160 on the outer surface 162 of the piping socket (60, 64) and a terminal surface 164. Such piping sockets (60, 64) are suitable for connection to a conduit 166, that is a portion of the conduit, by way of the compression fitting 150.

FIG. 27 illustrates a cross-sectional view of the compression fitting 150 in operable engagement with one of the piping sockets (60, 64) and a conduit 166. The compression nut 152 includes an open end 180, a compression end 182, an inner surface 184, and an outer surface 186. The compression end 182 of the compression nut 152 is provided with an annular hole 188 sized to permit a conduit 166 to be placed through the hole 188. The inner surface 184 of the compression nut 152 may include a female threaded section 190 and an angled section 192. The outer surface 186 of the compression nut 152 may be configured to be gripped with a tool or by hand. The outer surface 186 may, for example, have flat sections (not illustrated) that may be engaged by a tool such as, for example, a wrench, or the outer surface may, for example, have upstanding ridges 194 that promote gripping of the compression nut 152 by hand or tool.

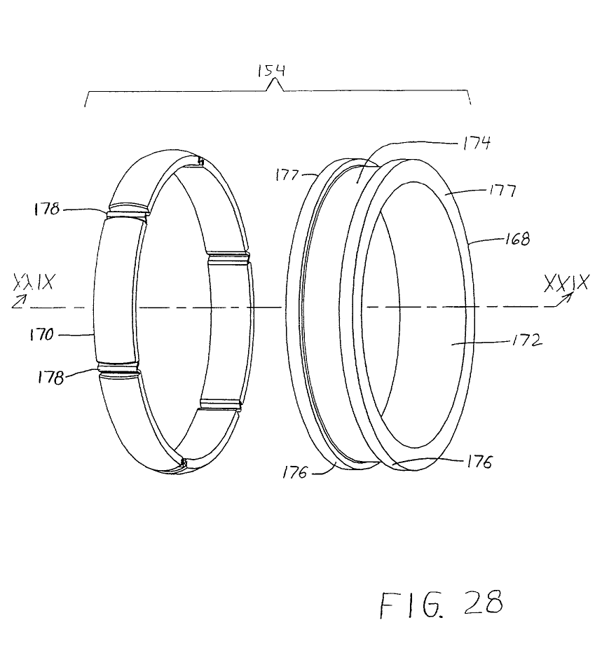

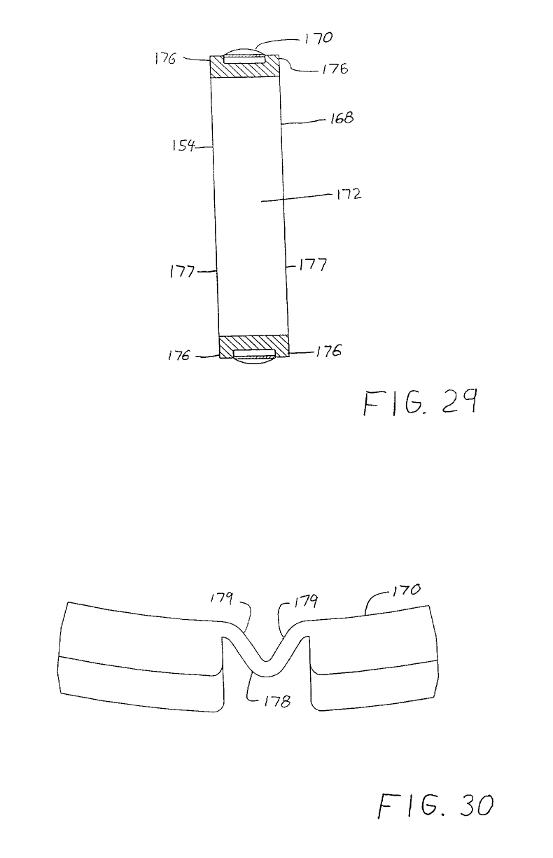

FIG. 28 illustrates an exploded assembly view of the sealing member 154 and FIG. 29 depicts the sealing member 154 in cross-section. As illustrated in FIGS. 28 and 29, the sealing member may be comprised of an inner ring 168 and an outer ring 170. The inner ring 168 may have an inner surface 172 and an outer surface 174, the outer surface 174 having an upstanding lip 176 on each side 177. A retaining portion 173, is defined by the outer surface 174 and upstanding lips 176 of the inner ring 168. The inner surface 172 of the inner ring 168 may be sized to engage the outer surface of the conduit 166. The inner ring 168 may be made from a material that is somewhat compressible such as, for example, a rubber or elastomer which may be an EPDM compound. The outer ring 170 may be disposed on the retaining portion 173 of the inner ring 168 intermediate the upstanding lips 176 of the outer surface 174. The outer ring 170 may be made from a deformable material such as, for example, a polymer which may be a polyamide such as nylon, and may include compression joints 178. The compression joints may be V-shaped segments in the outer ring 170. The V-shaped compression joint 179 may be compressed such that the sides become parallel to permit the outer ring 170 to contract when, for example, the outer ring 170 is compressed against the compression nut 152.

In operation, the compression nut 152 may be slidably disposed on the conduit 166 with the open end 180 of the compression nut 152 directed toward an open end of the conduit 166. The sealing member 154 may be slidably disposed on the conduit 166 such that the sealing member 154 is received within the open end 180 of the compression nut. The conduit 166 may be slidably received in the piping socket (60, 64) until it contacts the conduit curb 158. The sealing member 154 may be moved along the conduit 166 until it contacts the terminal surface 164 of the piping socket (60, 64) and the compression nut 152 may be threaded onto the piping socket (60, 64). The compression nut 152 may be tightened by utilizing a tool, such as, for example, a wrench, or may be tightened by hand. When the compression fitting 150 is attached to the piping socket (60, 64), the sealing member 154 is compressed between the piping socket (60,64), compression nut 152, and conduit 166, thereby creating a seal that prevents the medium flowing through the conduit 166 from bypassing the sealing member 154. More specifically, the sealing member 154 is in lateral contact with the terminal surface 164 of the piping socket (60, 64) and the inner surface 172 of the compression end 182 of the compression nut 152 in this configuration. The sealing member 154 is also in longitudinal contact with the angled section 192 of the inner surface 172 of the compression nut 152 in this configuration. The contact of the sealing member 154 with those surfaces, under compressive force, prevents the medium from leaking at the joint so formed.

The use of the compression fitting permits the conduit 166 to be easily connected to, or disconnected from the manifold 32. Connecting or disconnecting may be accomplished without disconnecting other joints in the conduit 166, and a tight seal may typically be achieved without the use of any specialized tools or solutions. Furthermore, if a leak occurs at the joint connected by way of the compression fitting 150, the leak may often be repaired by simply rotating the compression nut 152 into tighter engagement with the piping socket (60, 64).

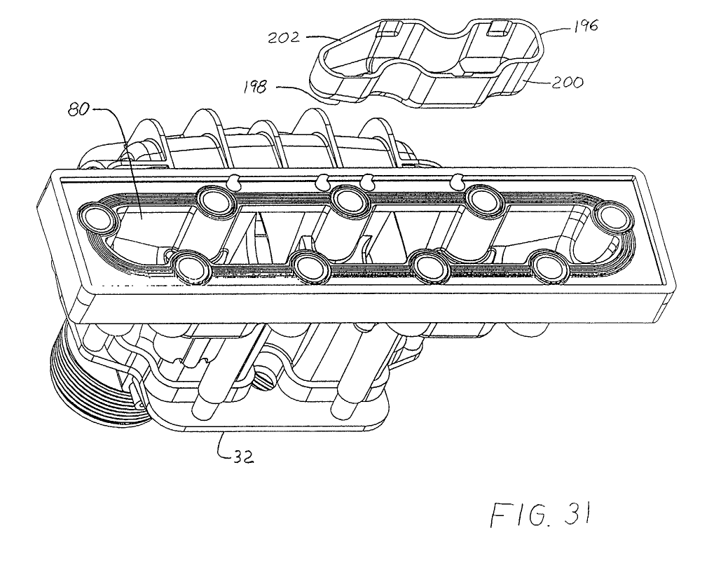

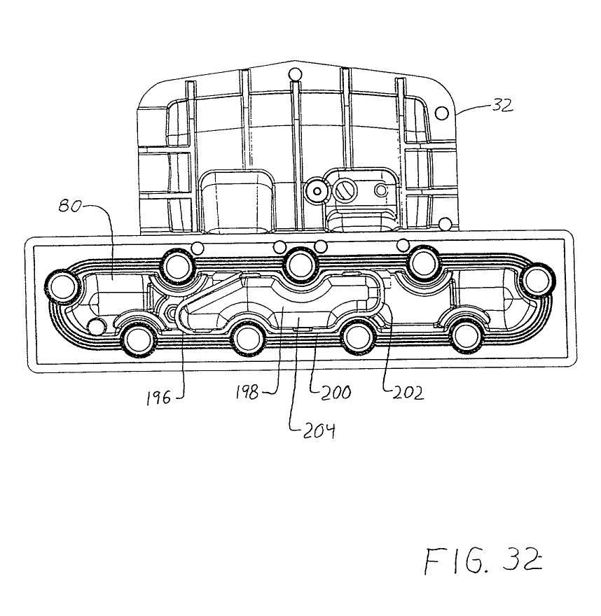

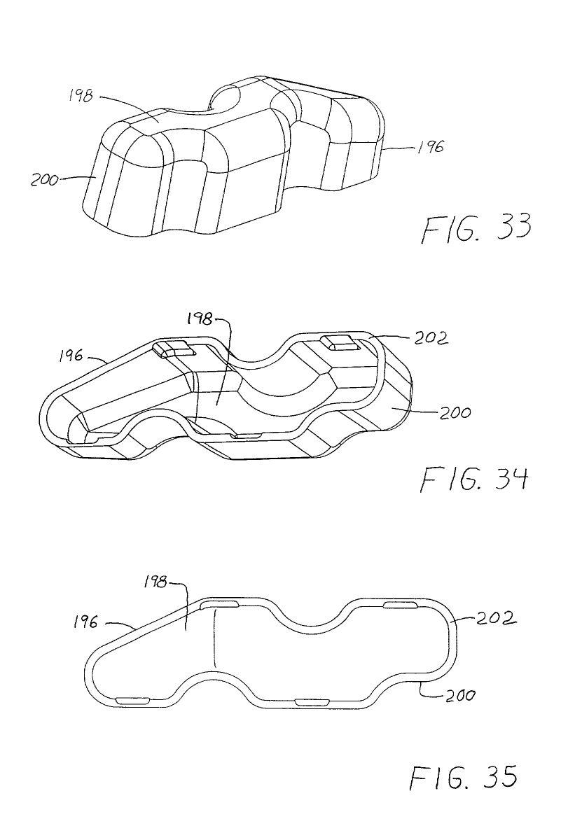

FIGS. 31-35 illustrate a flow cup 196 of the present invention. FIG. 31 depicts an exploded assembly view of the flow cup 196 and the manifold 32 and FIG. 32 illustrates the manifold 32 having the flow cup 196 inserted within the cavity 80 of the manifold 32. FIGS. 33-35 illustrate various views of the flow cup 196 without the manifold 32. The flow cup 196 may comprise a cup shaped body having a base 198 and an endless wall 200 ending in a rim 202 and defining an additional chamber section 204. One or more flow cups 196 may be inserted into the primary manifold 32 or the secondary manifold to add one or more additional chamber sections to the cavity 80 of the primary manifold 32 or secondary manifold. For example, a two-pass manifold may be converted to a four-pass manifold by inserting a flow cup 196 into the cavity 80. The flow cup 196 may be inserted into the manifold 32 such that the endless wall 200 separates the portion of the cavity 80 falling within the all 200 from the portion of the cavity 80 falling outside of the wall 200. The rim 202 of the flow cup 196 may sealingly contact the heat transferal subassembly 36 so that medium may flow into the additional chamber section 204 formed by the flow cup 196 from at least one inlet flow path, such as, for example, one or more tubes 38 of the heat transferal subassembly 36 and medium may flow out of the additional chamber section 204 by way of an outlet flow path, such as, for example, one or more tubes 38 of the heat transferal subassembly 36.

The present invention also includes a method of adding passes to a heat exchanging appliance by adding one or more removable flow cups 196 or dividers (not shown) to the primary manifold 32 or the secondary manifold of the heat exchanging appliance. For example, a flow cup 196 may be added to a manifold cavity 80 to divide the cavity 80 into at least one additional chamber 204. Each chamber 204 that is not in fluid communication with either the inlet port 62 or the outlet port 66 may be placed in fluid communication with at least one inlet flow path, such as, for example, a tube 38 of the heat transferal subassembly 36, and at least one outlet flow path, such as, for example, a tube 38 of the heat transferal subassembly 36, so that the medium will circulate through each chamber (68, 70. 204). Thus a two-pass manifold may be converted into a four-pass manifold. The flow cup 196 or divider may sealingly engage the heat transfer subassembly 36 and divide the cavity 80 of the manifold 32 to prevent medium from flowing from one chamber (68, 70. 204) of the manifold 32 to another chamber (68, 70. 204) of the manifold 32.

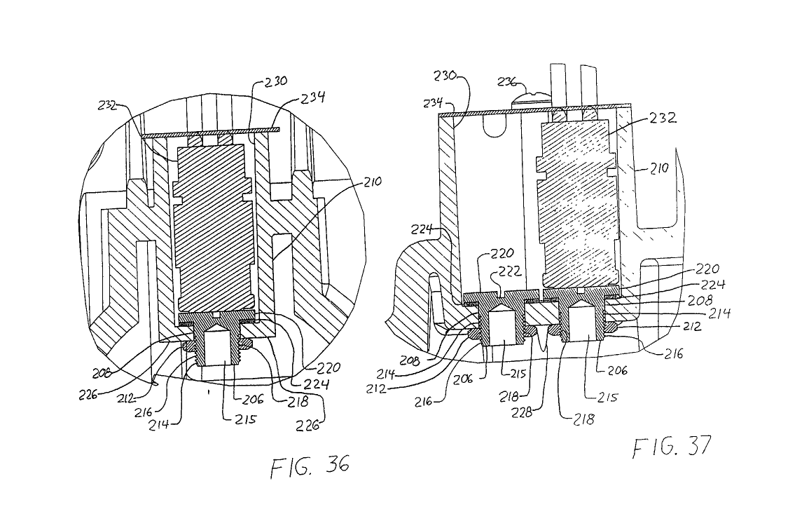

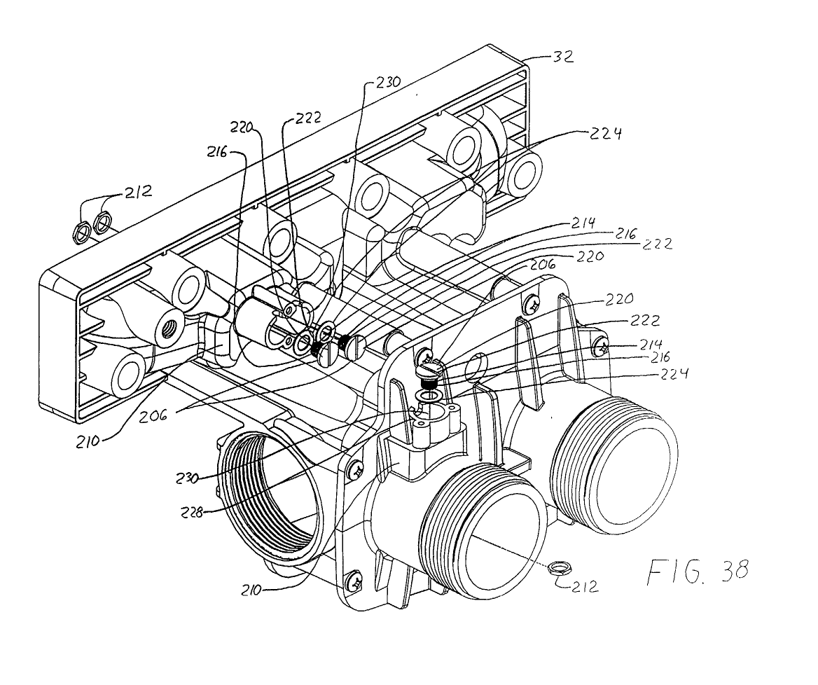

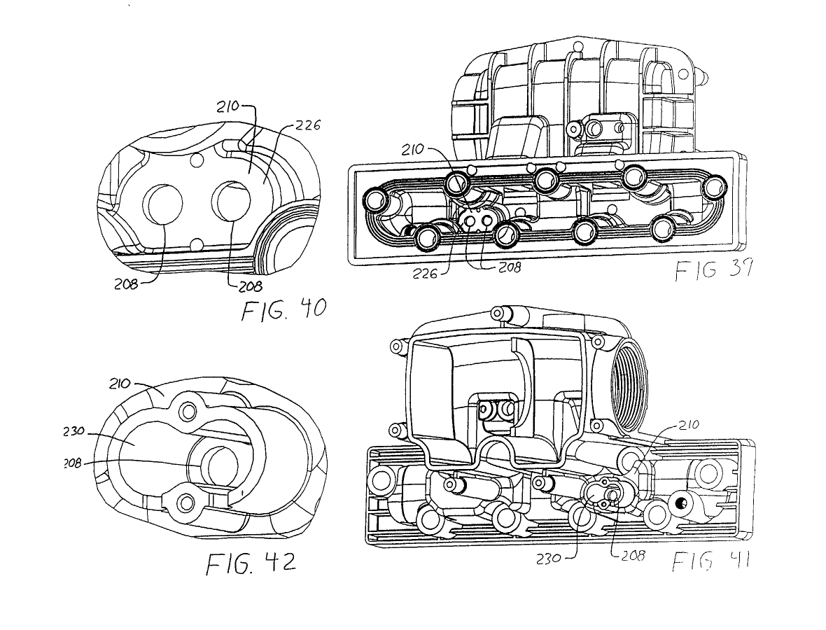

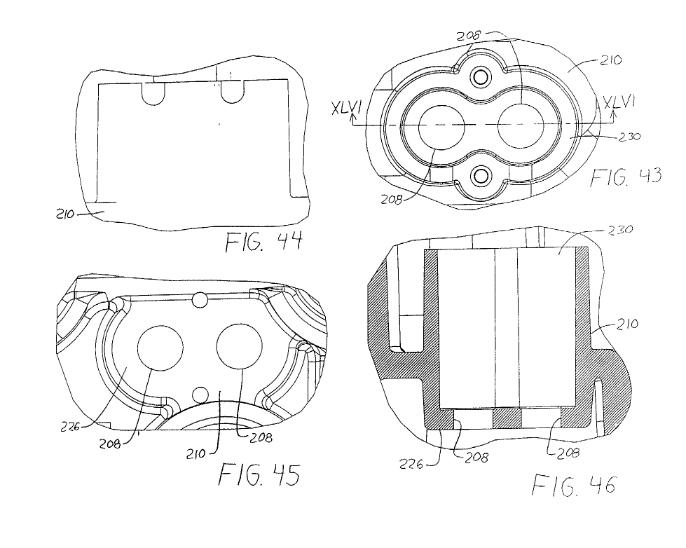

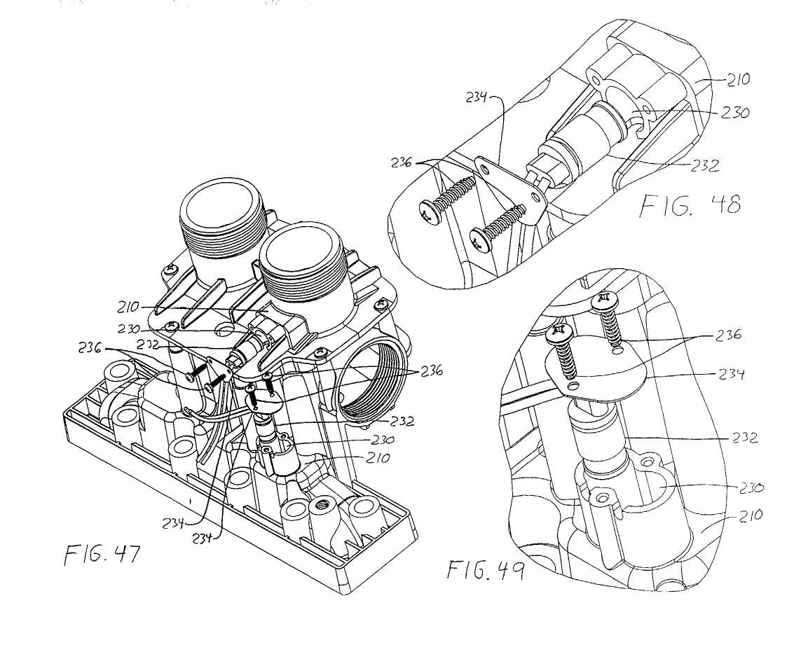

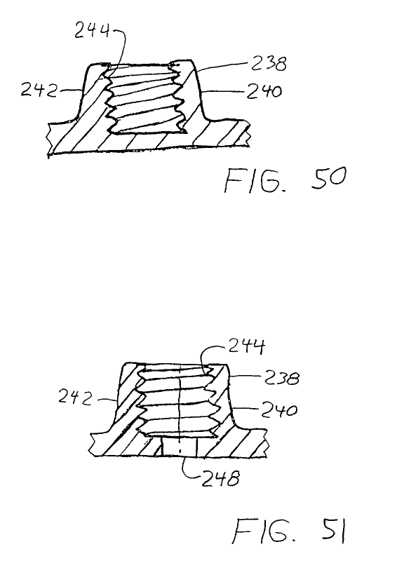

FIGS. 36-49 illustrate an apparatus for sensing the temperature of a medium in a non-conductive housing 210. The apparatus includes a heat conductive stud 206 disposed through a hole 208 in the housing 210 of, for example, a polymer manifold 32, and secured by a fastener such as, for example, a nut 212. The stud 206 may have a shaft 214 having a male thread 216 for complimentary engagement with a female thread 218 on the nut 212. The stud 206 may also have a head 220 having a key 222, such as, for example, a slot, so that a tool, such as, for example, a standard screwdriver, may engage the stud 206 to rotate the stud 206 in relation to the nut 212. The shaft 214 of the stud 206 may also have a hollow 215 to permit the sensed medium to flow into the stud 206.

The heat conductive stud 206 and nut 212 may be fabricated from many heat conducting materials including steel, iron, copper, stainless steel, brass and bronze. The skilled artisan will readily appreciate that the materials from which the stud 206 and nut 212 are fabricated may be advantageously selected based on their compatibility with the medium being handled and the environment, including, for example, the pressure and temperature conditions, to which the stud 206 and nut 212 will be exposed.

The housing 210 may additionally have an inner surface 226 having a protrusion 228 that engages the nut 212 to prevent rotation of the nut 212, and a sensor socket 230 in which a commercially available temperature sensor 232 such as that temperature sensor manufactured by CEMCO of Tennessee under Model No. 4302538 may be disposed. A sensor cover 234 may also be provided over the sensor socket 230, to hold the temperature sensor 232 in place, to protect the temperature sensor 232, and to minimize heat transfer between the socket 230 and ambient air. The sensor cover 234 may be attached to the housing 210 by many advantageous means including, for example, direct engagement between the cover 234 and the housing 210, or attachment by one or more screws 236.

The sensor cover 234 may be fabricated from many materials including metal, plastic or rubber. A metal or plastic sensor cover may include a rubber portion to seal the sensor socket 230 to prevent outside contaminants from contacting the temperature sensor 232.

A washer 224 may optionally be placed on the shaft 214 of the stud 206 before the stud shaft 214 is placed through the hole 208 in the housing 210 to facilitate a seal between the stud 206 and the housing 210. The washer 224 may be fabricated from many different materials including, for example, a fibrous material which may be advantageous when employing a metal stud 206 and a polymer housing 210.

In operation, the nut 212 may be placed on the inner surface 226 of the housing 210 adjoining the hole 208. The stud 206 may be placed through the hole 208 in the housing 210 and the shaft 214 of the stud 206 may be threaded into the nut 212. A temperature sensor 232 may be disposed in a sensor socket 230 formed on the manifold housing 210 with the sensing surface 238 of the temperature sensor 232 contacting the stud 206. In this way, the temperature sensor 232 is isolated from the medium which may contain materials that could damage the temperature sensor 232. The temperature of the medium is readily sensed by the temperature sensor 232 because heat from the medium is conducted through the heat conductive stud 206. The hollow 215 of the stud 206 permits the medium to be in close proximity to the temperature sensor 232 to minimize the amount of time required for the temperature sensor 232 to sense a change in medium temperature. The sensor 232 may then provide a control signal to a controller or a gauge to provide an indication of the fluid temperature. The use of the stud 206 as described hereinabove also prevents leakage that commonly occurs when a conventional temperature sensor is inserted through the housing 210 to directly contact the medium.

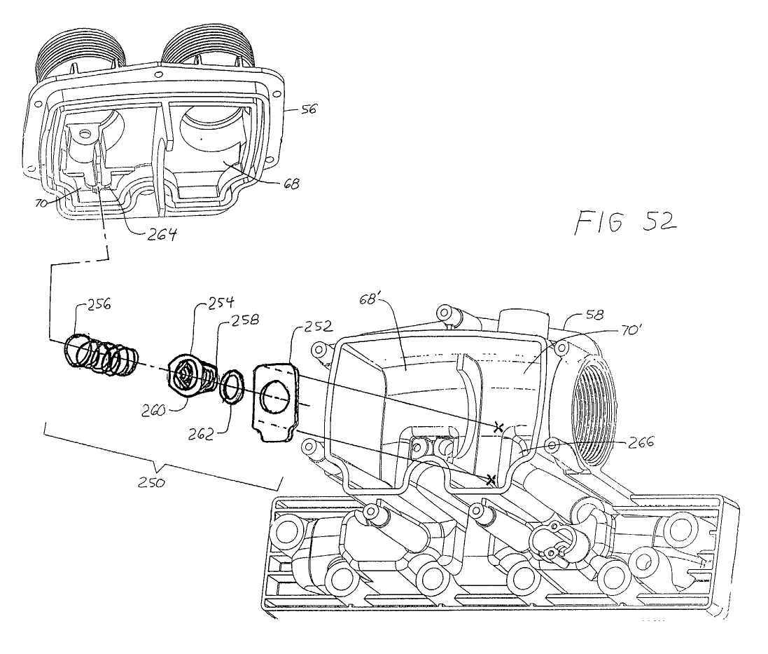

FIGS. 50 and 51 illustrate a blind threaded hole 238 of the present invention. The blind threaded hole 238 includes a fitting engaging portion 240 for complimentary engagement with a fitting such as, for example, a control device or sensor (not shown). The fitting engaging portion 240 may include a wall 242 projecting from the housing 210. The wall 242 may furthermore have a female thread 244 for engagement with a fitting having a male thread (not shown). As FIG. 50 illustrates, when the housing 210 is manufactured, the portion of the housing 210 enclosed by the fitting engaging portion wall 242 may not contain an opening 248. If the user desires to include a device utilizing a fitting at the blind threaded hole 238, the portion of the housing 210 enclosed by the fitting engaging portion wall 242 may be breached by, for example, drilling the housing 210, to form an opening 248. A breached embodiment is illustrated in FIG. 51. The fitting may be threaded into the fitting engaging portion 240 of the breached blind threaded hole 238 to contact the medium contained within the housing 210.

FIGS. 3 and 26 illustrate the blind threaded hole 238 incorporated into a manifold 32 at a location at which the inlet medium pressure may be sensed or a pressure relief valve may be utilized. To utilize a control or sensing device (not shown), the portion of the housing 210 enclosed by the fitting engaging portion wall 242 is breached and a fitting is threaded into the fitting engaging portion 240 such that the medium may be incident on the control or sensing device through the opening 248.

FIG. 52 illustrates an exploded assembly view of the manifold 32 of the present invention including a thermostatic valve assembly 250. The thermostatic valve assembly 250 includes a thermostatic valve 254 and a biasing member 256 such as, for example, a coil spring. The thermostatic valve 254 contains a thermal expansion material known in the thermostatic valve art which operates the thermostatic valve 254 to permit or restrict flow as the temperature of the expansion material varies. A certain conventional thermostatic valve 254 that may be utilized in the present invention operates to permit flow through the thermostatic valve 254 when heated and to restrict flow through the thermostatic valve 254 when cooled. Alternately, other thermostatic valves having different operating characteristics may be employed in the present invention.

To prevent flow around the thermostatic valve 254, the valve 254 may be sealed to a port such as, for example, an intermediate outlet port 266, as illustrated in FIG. 52. A plate 252 may be provided to facilitate the seal between the thermostatic valve 254 and the intermediate outlet port 266. A washer 262 may also be provided between the thermostatic valve 254 and the plate 252 to interconnect and seal between the thermostatic valve 254 and plate 252.

The biasing member 256 may be disposed between the thermostatic valve 254 and an interface, such as, for example a spring seat 264, as illustrated in FIG. 52. The spring seat 264 may be utilized to retain the biasing member 256 in its desired orientation by, for example, sliding the biasing member 256 onto the spring seat 264. The inclusion of the spring seat 264 on the manifold 32 permits the optional use of the thermostatic valve assembly 250 so that the thermostatic valve assembly 250 may be selectively provided in the manifold 32. Use of the spring seat 264 also permits the thermostatic valve assembly 250 to be easily installed, thereby minimizing installation cost, and disposed entirely within the manifold 32, thereby further minimizing penetrations into the pipeline and manifold 32.

Those of ordinary skill in the art will recognize that many modifications and variations of the present invention may be implemented. The foregoing description and the following claims are intended to cover all such modifications and variations. Furthermore, the materials and processes disclosed are illustrative of the invention but are not exhaustive. Other materials and processes may also be used to utilize the present invention.

What is claimed is:

1. A bypass valve for permitting a medium passing into a chamber of a housing to selectively bypass the chamber when the medium achieves a preselected pressure within the chamber, said bypass valve comprising:
a poppet movably supported within the chamber between sealing engagement with an outlet in the chamber and non-sealing engagement with said outlet; and
an adjustable actuation assembly attached to said poppet and protruding from the housing for external access thereto, said actuation assembly selectively applying a biasing force to said poppet to retain said poppet in sealing engagement with said outlet until the medium pressure exceeds said biasing force.

2. The bypass valve of claim 1, wherein the housing includes a removable plug, said plug engaging said stop of said shaft to permit removal of the bypass valve.

3. The bypass valve of claim 2, wherein said removable plug includes external threads and said housing includes internal threads for complimentary engagement with said external threads of said removable plug.

4. The bypass valve of claim 3, wherein said removable plug includes a gripping portion, whereby said removable plug may be rotated.

5. The bypass valve of claim 4, wherein said gripping portion includes an endless wall comprising six linear sides.

6. The bypass valve of claim 2, wherein said adjustable actuation assembly includes a follower having at least one anti-rotational surface, said at least one anti-rotational surface including two bifurcations and said plug includes two standing ribs for complimentary engagement with said two bifurcations.

7. The bypass valve of claim 2, wherein said adjustable actuation assembly includes a shaft, further comprising a shaft gasket disposed between said removable plug and the shaft.

8. The bypass valve of claim 2, further comprising a plug gasket disposed between said housing and said removable plug.

9. The bypass valve of claim 1, wherein said actuation assembly comprises:
a shaft, movably supported in the housing and having a proximal end extending outwardly from the housing and a distal end extending into the housing; and
a biasing member disposed on said shaft to engage said poppet, said biasing member selectively applying a biasing force to said poppet upon the application of an external force to said shaft to move said shaft relative to the appliance housing.

10. The bypass valve of claim 9, wherein said biasing member is a coil spring.

11. The bypass valve of claim 9, wherein said distal end of said shaft includes a poppet retaining member engagement portion, further comprising a poppet retaining member for engaging said poppet retaining member engagement portion to retain said poppet on said shaft.

12. The bypass valve of claim 11, wherein said poppet retaining member engagement portion includes an endless slot extending around said shaft and said poppet retaining member includes a retaining ring.

13. The bypass valve of claim 9, further comprising a shaft gasket disposed between said housing and said shaft.

14. The bypass valve of claim 9, further comprising a key in said proximal end of said shaft to facilitate rotation of said shaft.

15. The bypass valve of claim 9, wherein said shaft further comprises a stop and a threaded follower segment intermediate said distal end and said stop, the bypass valve further comprising a follower having at least one anti-rotational surface and a threaded hole, said anti-rotational surface engaging the housing, and said threaded hole engaging said threaded follower segment of said shaft, whereby said follower moves along said threaded follower segment of said shaft when said shaft is rotated.

16. The bypass valve of claim 15, wherein said shaft includes a threaded segment intermediate said proximal end and said stop, further comprising a nut having a threaded hole for complimentary engagement with said threaded segment, said nut for engaging a portion of said threaded segment that is disposed through said appliance housing.

17. The bypass valve of claim 15, further comprising a washer disposed intermediate said follower and said biasing member.

18. The bypass valve of claim 15, wherein said stop includes a collar extending axially from said shaft.

19. An externally adjustable bypass valve for an appliance, the appliance having a housing, comprising:
a shaft having a proximal end extending through the appliance housing, a distal end, a stop, a threaded follower segment intermediate said distal end and said stop, and a key in said proximal end to facilitate rotation of said shaft;
a follower having at least one anti-rotation surface and a threaded hole, said anti-rotation surface engaging the housing, and said threaded hole engaging said threaded follower segment of said shaft, whereby said follower moves along said threaded follower segment of said shaft when said shaft is rotated;
a poppet slidably disposed on said distal end of said shaft; and
a biasing member disposed intermediate said follower and said poppet.

20. An externally adjustable bypass valve for an appliance, the appliance having a housing, and the housing having a threaded plug hole, the externally adjustable bypass valve comprising:
a removable plug having a threaded surface attached to the appliance housing at the threaded plug hole by said threaded surface, said removable plug having two standing ribs and a shaft receiving hole;
a shaft having a proximal end extending through the appliance housing, a distal end, a retaining collar, a threaded follower section intermediate the distal end and the retaining collar, said shaft having a threaded retaining segment intermediate said proximal end and said retaining collar, an endless groove intermediate said distal end and said threaded follower segment, and a key in said proximal end to facilitate rotation of said shaft;
a follower having two bifurcations and a hole, said threaded hole engaging said threaded follower section of said shaft, and said bifurcations engaging said standing ribs of said plug, whereby the follower moves along the threaded follower section of the shaft when the shaft is rotated;
an adjustment nut having a threaded hole for complimentary engagement with said threaded segment, to clamp said shaft to said removable plug;
a retaining ring engaging said shaft at said endless groove;
a poppet slidably disposed on said shaft intermediate said retaining ring and said follower; and
a biasing member disposed intermediate said follower and said poppet.

21. A method of controlling the pressure in a high pressure chamber with respect to the pressure in a low pressure chamber in fluid communication with the high pressure chamber in a heat exchanging appliance, comprising:
biasing a poppet between the high and low pressure chambers; and
varying the biasing force applied to the poppet from outside the high and low pressure chambers.

22. The method of claim 21 wherein biasing is accomplished by a biasing member.

23. The method of claim 22 wherein said biasing member is a coil spring.

24. The method of claim 23 wherein varying includes compressing the coil spring by rotating a shaft.

25. A method of controlling the pressure between a high pressure chamber and a low pressure chamber, comprising:
providing a bypass port in fluid communication with the high and low pressure chambers;
biasing a poppet against the bypass port, whereby the force from the high pressure chamber is opposed by said biasing; and
varying the biasing force applied to the poppet from outside the high and low pressure chambers.

26. An externally adjustable bypass valve for a heat exchanging appliance, said appliance having a high pressure chamber and a low pressure chamber, comprising:
means for biasing a poppet between the high and low pressure chambers; and
means for varying the biasing force applied to the poppet from outside the high and low pressure chambers.

27. A compression fitting for connecting a conduit and a piping socket, wherein the conduit is slidably received in the piping socket and the piping socket has a threaded surface, comprising:
a compression nut having a compression end and a threaded surface engaging the threaded surface of the piping socket;
an inner ring having a retaining portion, said inner ring disposed on the conduit intermediate said compression end of said compression nut and the piping socket; and
an outer ring disposed on said retaining portion of said inner ring.

28. The compression fitting of claim 27, wherein said compression nut has an outer surface, said outer surface being shaped to promote gripping of said compression nut when rotating said compression nut.

29. The compression fitting of claim 28, wherein said outer surface further comprises a plurality of flat surfaces.

30. The compression fitting of claim 28, wherein said outer surface further comprises a plurality of upstanding ridges.

31. The compression fitting of claim 27, wherein said compression nut has an angled section that sealingly contacts said outer ring.

32. The compression fitting of claim 27, wherein said retaining portion of said inner ring is defined by:
an outer surface of said inner ring;
a first edge of said outer surface having an upstanding lip; and
a second edge of said outer surface having an upstanding lip.

33. The compression fitting of claim 27, wherein said outer ring includes at least one compression joint.

34. The compression fitting of claim 33, wherein said at least one compression joint is a V-shaped member.

35. A manifold, comprising:
a housing;
at least one piping socket disposed on said housing;
a conduit slidably engaging said piping socket; and
a compression fitting sealingly engaging said at least one piping socket and said conduit.

36. The manifold of claim 35, wherein the piping socket has a threaded surface, and wherein the compression fitting further comprises:
a compression nut having a compression end and a threaded surface for complimentary engagement with said threaded surface of said piping socket; and
a sealing member disposed on said conduit intermediate said compression end of said compression nut and said piping socket.

37. The manifold of claim 36, wherein said sealing member further comprises:
an inner ring having a retaining portion; and
an outer ring disposed on said retaining portion of said inner ring.

38. The compression fitting of claim 37, wherein said outer ring includes at least one compression joint.

39. A method of connecting a conduit and a piping socket of a manifold, said piping socket having a threaded surface, comprising:
sliding a compression nut having an open end, a compression end and a threaded surface on the conduit with the open end of the compression nut directed toward an open end of the conduit;
sliding the sealing member on the conduit such that the sealing member is received within the open end of the compression nut;
sliding the conduit into the piping socket; and
threading the compression nut onto the piping socket.

40. The method of claim 39, further comprising disposing an outer ring on a retaining portion of an inner ring to form a sealing member.

41. The method of claim 40, further comprising forming at least one compression joint in the outer ring.

42. A flow cup for placement in a manifold, comprising a flow cup body having an endless wall defining a chamber.

43. The flow cup of claim 42, wherein said endless wall has a rim for engagement with a heat transferal subassembly.

44. The flow cup of claim 42, wherein said flow cup is placed in a cavity of the manifold and wherein said flow cup body is shaped to prevent medium in the cavity from flowing around the flow cup.

45. A removable flow cup for placement in a manifold to divert medium flow from at least one inlet flow path to at least one outlet flow path, comprising:
a base;
an endless wall attached to said base, said wall defining a chamber, said chamber being in fluid communication with the at least one inlet flow path and the at least one outlet flow path, whereby medium flows into said chamber from the at least one inlet flow path and fluid in said chamber flows into the at least one outlet flow path; and
a rim on said endless wall, said rim for sealingly engaging the at least one inlet flow path and the at least one outlet flow path.

46. A heat exchanger, comprising:
a primary manifold;
at least one flow cup disposed in said primary manifold;
a heat transferal subassembly having a first end and a second end, wherein said first end is connected to said primary manifold; and
a secondary manifold connected to said second end of said heat transferal subassembly.

47. The heat exchanger of claim 46, further comprising at least one flow cup disposed in said secondary manifold.

48. A heat exchanger, comprising:
a secondary manifold;
at least one flow cup disposed in said secondary manifold;
a heat transferal subassembly having a first end and a second end, wherein said second end is connected to said secondary manifold; and
a primary manifold connected to said first end of said heat transferal subassembly.

49. A method of converting a manifold to operate with a desired number of passes, comprising:
providing a removable divider in a manifold cavity to prevent fluid from passing from one portion of the manifold cavity to another portion of the manifold cavity.

50. An apparatus for conveying the temperature of a medium in a housing having a hole to a temperature sensor, comprising:
a thermally conductive stud disposed through the hole in the housing and communicating with the temperature sensor; and
a fastener retaining said stud in the hole.

51. The apparatus of claim 50, wherein said stud as fabricated from said thermally conductive material selected from the group consisting of steel, iron, stainless steel, copper, brass and bronze.

52. The apparatus of claim 50, wherein said stud has a threaded shaft and said fastener is a nut that threads on said shaft.

53. The apparatus of claim 52, wherein the housing has an inner surface, further comprising a protrusion on the inner surface of the housing for engaging the nut.

54. The apparatus of claim 50, wherein said stud has a keyed head for engaging a tool.

55. A method of sensing the temperature of a medium contained within a nonconductive housing, comprising:
fastening a conductive stud in a hole in the housing; and
disposing the sensing surface of a temperature sensor on the stud.

56. A method of retaining an insertion apparatus in a manifold, comprising:
providing a fitting engaging portion on the manifold;
removing a portion of the manifold enclosed by the fitting engaging portion; and
engaging the insertion apparatus with the fitting engaging portion.

57. The method of claim 56, wherein said removing includes drilling the portion of the manifold enclosed by the fitting engaging portion.

58. The method of claim 56, wherein said engaging includes threading the insertion apparatus into the fitting engaging portion.

59. A thermostatic valve assembly, comprising:
a thermostatic valve that operates to selectively permit medium flow; and
a biasing member urging said thermostatic valve toward a port to restrict flow around the thermostatic valve.

60. The thermostatic valve assembly of claim 59, further comprising an interface for selectively retaining and orienting said thermostatic valve assembly.

61. The thermostatic valve assembly of claim 60, wherein said interface includes a spring seat.

62. The thermostatic valve assembly of claim 61, wherein said spring seat engages said biasing member.

63. The thermostatic valve assembly of claim 59, further comprising a plate that at least partially obstructs a port.

64. The thermostatic valve assembly of claim 63, further comprising a washer disposed between said plate and said thermostatic valve.

65. The thermostatic valve assembly of claim 59, wherein said biasing member is a coil spring.

66. A thermostatic valve assembly for controlling the flow of a medium in a manifold, comprising:
a plate for at least partially obstructing a port in the manifold;
a thermostatic valve connected to said plate;
a biasing member applying force to said thermostatic valve; and
an interface retaining said biasing member.

67. A method of controlling the flow of a medium through a port comprising:
biasing a thermostatic valve to restrict the flow of medium through the port; and
adjusting the biasing force applied in relation to the temperature of the medium.

68. A method of manufacturing a manifold comprising:
forming an interface on the manifold to selectively retain a thermostatic valve.

69. A manifold, comprising:
a thermostatic valve
means for biasing the thermostatic valve to restrict the flow of medium through a port; and
means for adjusting the biasing force applied in relation to the temperature of the medium.

70. The manifold of claim 69, further comprises a means for selectively retaining said means for biasing in a predetermined orientation.

71. A manifold having a blind threaded hole for engaging an inserted apparatus, comprising:
a senser engaging portion extending from the manifold; and
a portion of the manifold enclosed by said sensor engaging portion.

72. The blind threaded hole of claim 69, wherein the sensor engaging portion further comprises a wall projecting from the manifold.

73. The blind threaded hole of claim 70, wherein the wall further comprises a threaded surface.

74. The blind threaded hole of claim 69, wherein the portion of the manifold enclosed by said sensor engaging portion is removable.
